(19) United States
(12) Patent Application Publication
(10) Pub. No.: US 2010/0164430 A1
(43) Pub. Date: Jul. 1, 2010

(54) Intelligent Adaptive Energy Management System and Method for Using

(75) Inventors: CUI LU, Guangzhou (CN); PENGCHENG ZOU, Beijing (CN); DALLAS LEE NASH, II, Ridgeland, MS (US)

Correspondence Address: Nyemaster, Goode, West, Hansell & O''Brien, P.C., 625 First Street SE, Suite 400, Cedar Rapids, IA, 52401, US

(73) Assignee: VBI 2000, LLC, Bartonville, TX (US)

(21) Appl. No.: 12/353,715

(22) Filed: Jan. 14, 2009

(30) Foreign Application Priority Data
Dec. 31, 2008 (CN) 200820184140.9

(51) Int. Cl. H02J 7/00; H02J 7/04; H02J 3/02

(52) U.S. Cl. 320/103; 320/162; 320/152; 320/134; 320/145; 307/80; 320/116

(57) ABSTRACT

An intelligent adaptive energy management system and method that manages the charge and discharge process as well as the environmental quality of the energy resource to maximize its safety and its energy output. The system includes multiple features that may be used alone or in combination. One feature includes one or more sensors capable of measuring various characteristics of the battery cells and their environment such as cell temperature, rate of rise in cell temperature, cell voltage, cell density, cell internal resistance and cell shape deformation. The sensors communicate the measured data to a controller which controls activities such as cell charging, cell discharging, cell balancing, and/or cell availability to provide energy to the device served. Another feature includes a charging module in communication with the controller adapted to provide varying types and/or durations and/or amplitudes of the charge to the cells. Another feature includes a discharge system and methodology in communication with the controller that employs at least one first battery cell and at least two second battery cells adapted to work together in a complementary manner. Another feature includes an active cell balance system and methodology for balancing battery cells. Circuitry, firmware, and programmable software may be used to implement and control the above systems and methodologies to push energy resource capacity beyond its normal limits in a safe and predictable manner.

This application claims priority to Chinese patent application number 200820184140.9 filed on Dec. 31, 2008, the disclosure of which is hereby incorporated by reference.

### BACKGROUND

Portable electronic devices are playing an increasingly important role in society. The electronic devices take the form of cellular phone/smart phones, personal digital assistants (PDA), notebooks, Netbooks, Ultra-Mobile Personal Computers (UMPC), and devices that support portable gaming. These electronic devices are found in both business and everyday life. With the development of more capable hardware and software, more functions can be performed by these portable devices but limited battery life has impacted the utilization and acceptance of the new functions. Users of the portable electronic devices expect that the power (batteries) for these devices be lighter and slimmer while supporting the desired usage and run-times. In the past decade, lithium batteries have replaced nickel metal hydrate batteries and become the number one battery used in these portable devices. One reason lithium batters are used is because lithium batteries provide a very high energy density from the volumetric and gravimetric point of view. However, even the lithium battery has been unable to meet the power demand of the market.

In addition, the number of catastrophic failures of lithium battery cells in consumer electronic devices has resulted in hundreds of millions of dollars in losses to this market segment and is bringing government attention to the issue of powering consumer electronic devices. As a result, the manufacturers of the consumer electronic devices are demanding that the power source be safe. The need for a lighter, slimmer, more powerful, and safe power source is an ever increasing and prominent issue in the portable electronics market.

### SUMMARY

An intelligent adaptive energy management system and method that manages the charge and discharge process of the energy resource to maximize its safety and its energy output. The system includes multiple features that may be used alone or in combination.

One feature of the invention includes one or more sensors capable of measuring the battery cell environment, the various characteristics of the battery cells such as cell temperature, rate of rise in cell temperature, cell voltage, cell density, cell internal resistance and cell shape deformation, and the health status of the battery cells. The sensors communicate the measured data to a controller which may control cell charging, cell discharging, cell balancing, and/or cell availability to provide energy to the device served. This ability to monitor individual cell status provides the basis to gauge battery cell safety and increase the safety of the battery cell charge/discharge process.

Another feature includes a charging module in communication with the controller adapted to provide varying types and/or durations and/or amplitudes of the charge to the cells. This charging module results in the ability to reach optimal charge level in each cell with increased safety, speed, and efficiency in the charge process.

Another feature includes a discharge system and methodology in communication with the controller that employs at least one first battery cell and at least two second battery cells adapted to work together in a complementary manner. This discharge system results in increased energy output from the second (lithium polymer) cells.

Another feature includes an active cell balance system and methodology for balancing battery cells to increase safety and efficiency in the charge/discharge process.

Circuitry, firmware, and programmable software may be used to implement and control the above systems and methodologies to push energy resource capacity beyond its normal limits in a safer and more predictable method.

### BRIEF DESCRIPTION OF THE DRAWINGS

FIG. 1a shows an illustration of reaction interface;

FIG. 1b shows an equivalent circuit;

FIG. 2a is a graph showing the galvanostatic method used to measure the battery status input galvanostatic current pulse;

FIG. 2b is a graph showing the galvanostatic method used to measure the battery status response voltage change;

FIG. 3 is a graph showing a charging pulse wave form;

FIG. 4 is a graph showing the discharging logic with short-term charging current pulse;

FIG. 5 shows an embodiment of the invention wherein each Lithium Polymer battery pack has six battery cells (with three in series and two in parallel) in communication with nine Nickel Metal Hydrate batteries (connected in series);

FIG. 6 shows a configuration of batteries and switches used with the active cell balance method;

FIG. 7 is a circuit diagram showing a deformation sensor;

FIG. 8 is a block diagram of an embodiment of the intelligent adaptive battery management system; and

FIG. 9 is a flow chart showing an embodiment of the flutter charge process.

### DETAILED DESCRIPTION

This invention is an intelligent adaptive energy resource management system and method adapted to maximize optimal energy resource output, maximize energy resource safety, maximize energy resource life, maximize energy resource efficiency, and maximize the opportunities to improve the foregoing. The system includes multiple features/components that may be used alone or in combination. Although one embodiment of the invention discloses the use of lithium or lithium polymer battery cells (referred to as “lithium”) combined with a nickel hydrate battery cells, any suitable battery cell chemistry may be used, including, but not necessarily limited to, lithium ion, zinc air, zinc oxide, super charged zinc oxide, and fuel cells.

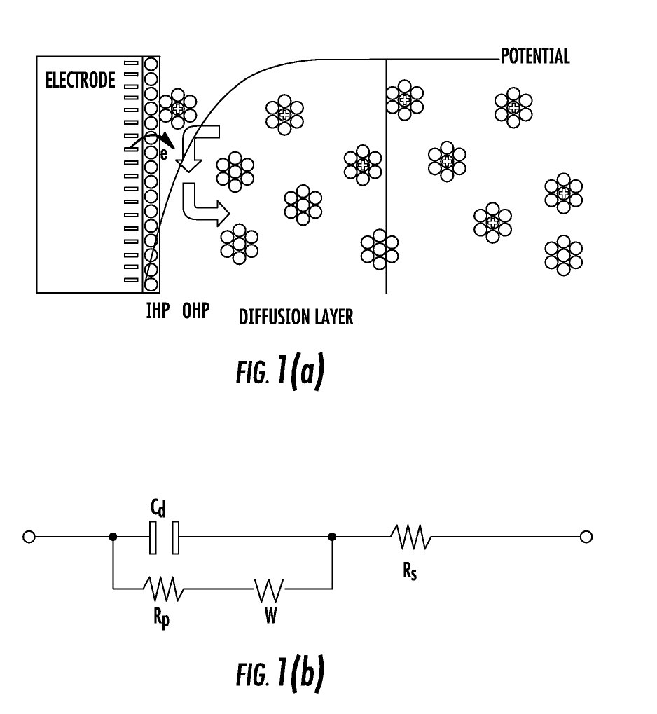

Generally, when charging Lithium secondary battery cells, the lithium ion (Li+) concentration will increase at the anode. The accumulation of lithium ions will create a concentration gradient that counters the ion movements in the charging electrochemistry reaction (FIG. 1a). From the aspect of an equivalent circuit model, this concentration gradient works like internal resistances and will decrease the charging efficiency of the battery cell (FIG. 1b).

When discharging the battery cell (or cells), the lithium ions will accumulate on the cathode. This accumulation will form a concentration gradient to counter the ions movement in the discharging electrochemistry reaction. From the aspect of an equivalent circuit model, this concentration gradient works like internal resistances and will decrease the efficiency of the battery cell. Battery cell efficiency (usage) may be increased by intelligently lowering the internal resistances or the resistance of equivalent (equivalence) circuit. This resultant phenomenon can be analyzed by the equivalent (equivalence) circuit shown in FIG. 1b where Rs is the electrolyte solution resistance, Rp is the polarization resistance, and W is the Warburg impedance.

The internal resistance, Rs, is related to the battery cell's internal chemistries and cannot be changed. However, the internal resistance can be used to discover the degree of battery cell decay. To measure the degree of battery cell decay, the increase of the internal resistance, Rs, is measured in relation to the decay of the internal material of the battery cell after a certain number of charge and discharge cycles. In some embodiments, the invention provides intelligent adaptive circuits to predict as well as determine when the internal resistance reaches, Rs, a level requiring that the use of the offending battery cell(s) be stopped due to increased risk of battery cell catastrophic failure.

The negative effects of the polarization resistance, Rp, and the Warburg impedance, W, can be reduced with the use of a capacitor or an adaptive capacitance module utilizing the properly designed charging voltage. As described below, this intelligent adaptive energy management system 500 provides intelligent adaptive circuits to predict as well as determine the proper charging voltage to maximize the reduction in the negative impact of the polarization resistance, Rp, and the Warburg impedance, W.

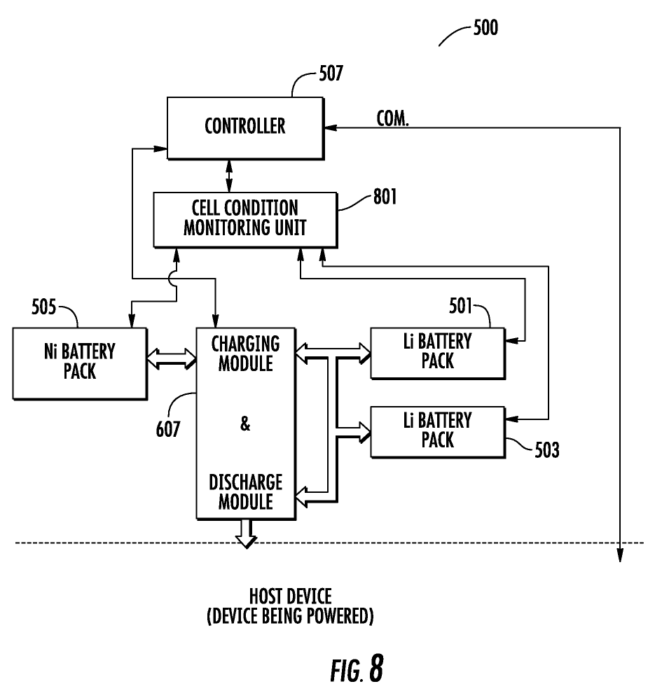

FIG. 8 shows a block diagram of the components of one embodiment of the intelligent adaptive energy management system 500. For convenience, FIG. 8 shows the system 500 located outside of the host device, however, it should be noted that the system 500 may also be located inside the host device. Further, in some embodiments, the system 500 is an after marked add-on. In these embodiments, the system 500 assists or replaces the host device's battery. Alternatively, the system 500 may be the only power source for the host device.

As shown in FIG. 8, one feature of the invention includes a battery cell condition monitoring unit 801 that monitors the individual battery cell(s) status, the battery cell packs 501, 503, 505, and/or their surrounding environment. In some embodiments, the cell condition monitoring unit 801 is included as part of a controller 507 and includes the circuit and its firmware. The cell condition monitoring unit 801 measures conditions at the battery cell and/or battery pack 501, 503, 505 level for values such as cell temperature, rate of rise in cell temperature, cell voltage, cell density, cell internal resistance and cell shape deformation. The sensors communicate the measured data to the controller 507 which uses all the data it collects to control cell charging, cell discharging, cell balancing, and/or cell availability to provide energy to the device served. Any suitable sensor may be used to measure the various cell values.

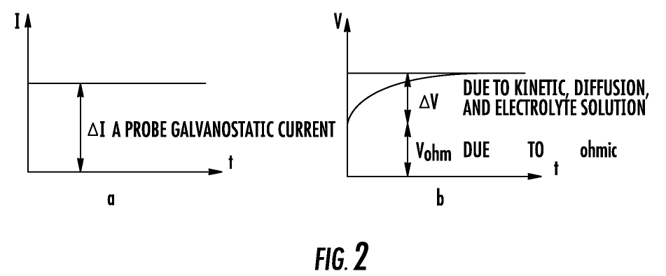

The galvanostatic pulse probing method is an example of a method used to measure the internal resistance and other electrochemistry parameters of the individual battery cell or cells. A galvanostatic pulse is periodically injected into the battery by cell condition monitoring unit 801 and the response is measured, stored, and analyzed by the controller 507. An example of the input and response curve is shown in FIGS. 2a and 2b respectively. As shown in FIG. 2b, Vₒₕₘ is immediately invoked by the constant current because of the ohmic resistance inside the battery. The ΔV has a time effect that comes from composite factors such as electrochemical reactions, charging of interfaces, and diffusion processes, etc. The ohmic resistance is measured as Vₒₕₘ/ΔI and used as a factor to reveal the material decay inside the battery cell. The controller 507 uses this data to develop real-time parameters that are used for battery cell management and to increase battery cell safety. As discussed in more detail below, if the measured value of any of the cell conditions is outside of the acceptable range and/or the battery cell health warrants, the controller 507 will stop the battery cell from supplying power.

In some embodiments, temperature is measured using thermistor arrays and/or discrete sensors for each battery cell, battery cell pack and/or the associated near-space environment. In one embodiment, the temperature information is considered with the parameters extracted by the galvanostatic pulse detection methodology and is used to evaluate the health condition of the battery cell. If the evaluation of the battery cell health condition warrants, the system will stop the affected battery cell(s) from supplying power as described below.

Chemistry failure inside the battery cell or battery cell packs sometimes causes the battery cell to bulge or change shape without significant temperature change. The bulge or deformation of the battery cell might come from crystallization or the gas generated from the internal chemical reaction. In some embodiments of the invention, the cell condition monitoring unit 801 comprises a sensor adapted to detect battery cell deformation. The deformation sensor may be able to detect a problem and take action earlier than the normal temperature sensor/control and will thereby prevent further harm to the battery cell and/or the device the battery is serving.

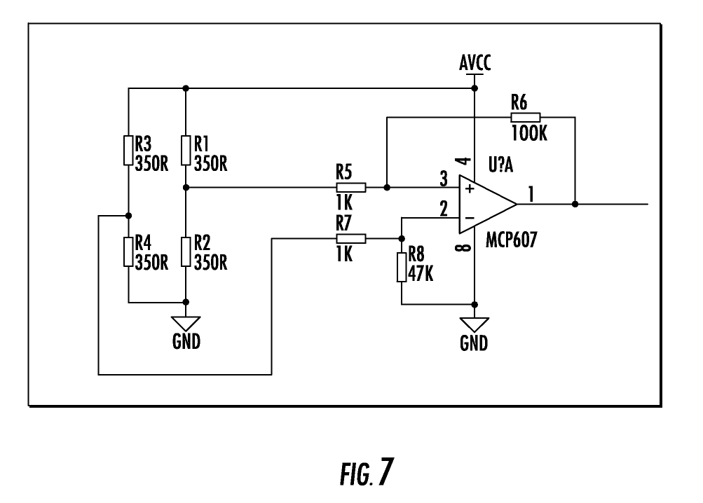

FIG. 7 shows an embodiment of the invention wherein the cell condition monitoring unit 801 comprises deformation sensors such as strain gauge or tension sensors 700 on one or more battery cells to measure the shape change at the individual cell level. For example, referring to FIG. 7, strain gauge technology is used in a Wheatstone bridge arrangement. Combined with the controller 507 and software, this smart signal monitor quickly amplifies and filters the small signals from circuit noise so the small signals can provide additional data. One or more sensors are used as the reference sensor for the system to detect change.

The controller 507 receives and stores the sensor data to develop real-time parameters that are used for battery cell management. If the measured value of any of the cell conditions (e.g. temperature, shape deformation, voltage) is outside of the acceptable range, the controller 507 will either switch off the power from the cell(s) or switch off overall power output immediately depending on the level of risk of catastrophic failure. If the offending cell(s) return to normality within measurable limits, the controller 507 will return the offending cell(s) to usable status. If the offending cell(s) begins to fail a second time (or other predetermined number of times) in the primary charge or discharge cycle, the controller 507 will mark the cell(s) in failure mode. If this happens, the failed cell(s) will not be available until the system has successfully completed an offline safety refresh cycle. If it cannot complete an offline safety refresh cycle, an internal database to controller 507 will mark the battery cell(s) unusable so it is no longer used. If the unusable (marked down) battery cell is part of a multi-cell implementation, it is possible that the battery cluster may remain useable but without full capacity.

In addition to the safety provided by the data collected by the cell condition monitoring unit 801 combined with the shut-down logic of the controller 507, in some embodiments the battery packs and the host device are also protected by using individual UL certified Lithium polymer battery cells and/or packs and internal UL certified cell fuses (not shown) internal to the packs 501, 503, & 505 to protect the individual cell from over current.

In some embodiments, the controller 507 also provides information feedback to the powered device. The information can be used to dynamically update the software on the host device, in this way the software learns and adapts to new and changing conditions, further the intelligent adaptive energy resource management system 500 is constantly evaluated and fine-tuned. And, in the event or risk of catastrophic failure, the user is notified that the batteries 501 & 503 will stop providing power to the host device.

Another feature of the invention relates to charging and discharging techniques which increases the energy output, the life cycle, safety and efficiency of the battery cell(s). As shown in FIG. 8, charging/discharging module 607 is in communication with controller 507 to control the rate at which battery packs 501, 503, & 505 and/or individual cells are charged and discharged. For most embodiments, a first battery cell (such as nickel hydrate battery 505) discharges into one or more second battery cells (such as Lithium polymer batteries 501, 503) to help the second battery cells maintain their charge and power the device.

Several charging/discharging techniques are described below including pulse charging, pulse discharging, fast pulse charging, and intelligent adaptable fast charge method. Each of the methods is a specific technique that applies a varying real-time algorithmic value that is modified by the controller 507 and embedded firmware/software in direct response to the real-time values as received by the sensors and sensor arrays and filtered or modified by historically appropriate values stored and updated within the controller's 507 storage and as also periodically updated by optional attachment to a more robust up-stream database of values maintained by the software on the user's notebook computer or other serviced device.

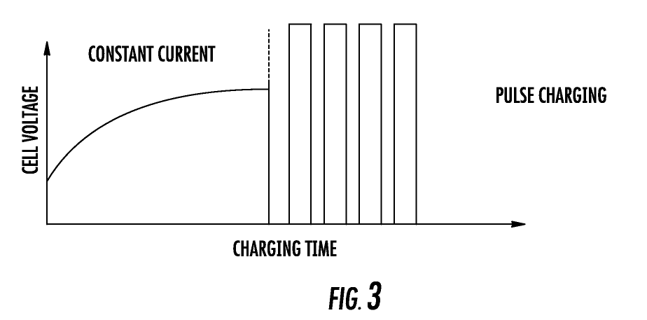

Pulse charging can charge batteries much faster than the traditional constant current followed by constant voltage charging method. In addition, pulse charge methods do not cause additional negative side-effects and/or gradient concentration that are found in traditional methods. Some embodiments of this invention include fast pulse charge methods as shown in FIG. 3. The battery cells are charged by an intelligent adaptable (adjustable) frequency pulse methodology. The average voltage of the pulse is no more than maximum voltage that any specific battery cell can tolerate, e.g. 4.25V. In some embodiments, while pulse charging takes place, the cell condition monitoring unit 801 monitors cell characteristics such as temperature and deformation to help keep the cell and/or cell packs in a safe condition.

In one embodiment, the invention enhances safety and performance with its intelligent adaptable fast charge method. The intelligent adaptable fast charge method is based on the current condition of the lithium battery cells and cell packs 501, 503. After the constant current stage of charging, the battery is charged by an intelligent adaptive (adjustable) constant or variable voltage pulse delivered by the Nickel Metal Hydrate battery 505 through the charging module 607. The charge pulse frequency and cycle are determined by the composite health status of the battery. The composite health status information includes the electrochemistry parameters determined by the controller 507. Traditional battery cell status is monitored and/or determined by the battery cell condition monitoring unit 801. The controller unit 507 determines the fast charge method to use (constant or variable) dependent upon current cell status in relation to stored historical data. The controller unit 507 also determines an optimized charge pulse frequency and voltage or current density.

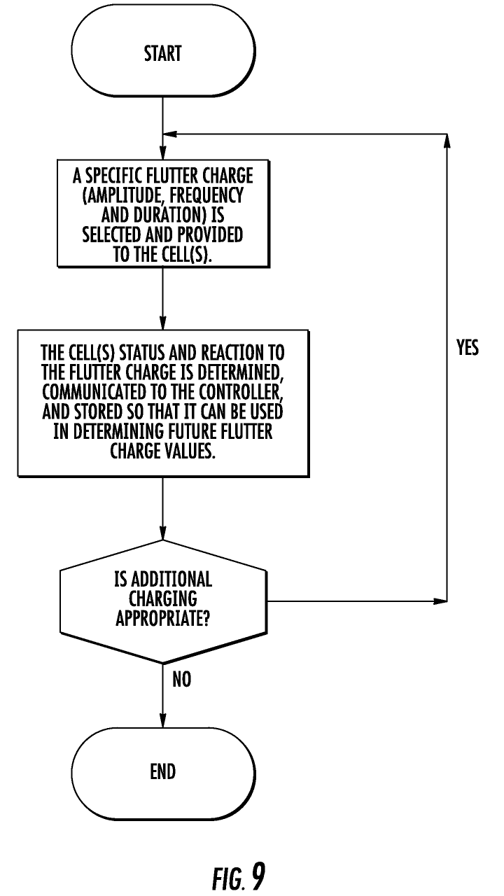

One embodiment of the adjustable charge method includes a flutter charge process as shown in FIG. 9. The flutter charge operation is consistent with the pulse methodology and operation except that the amplitude of the flutter charge is not the same as the amplitude of the pulse. With a flutter charge, the amplitude, frequency and the duration of the charge vary. The controller unit 507 determines the optimal formula for the amplitude, frequency and duration of the “flutter” charge for each specific cell configuration. After each flutter charge, the cell condition monitoring unit 801 analyzes the cell's reaction to the charge. The system learns what frequency, amplitude and duration of the flutter charge will increase the cell's charge capacity, longevity and performance. The system uses that optimal flutter charge to charge the cells.

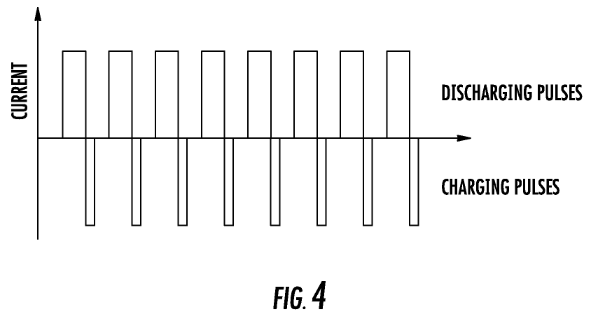

Traditionally the battery cell discharge characteristic is determined by the requirement of the outside electrical load. The continuous discharge of the battery cell will increase polarization resistance, Rp. Polarization resistance arises due to the increase of the double layer effects and negatively impacts battery cell performance. The double layer effects will be reduced if the charge accumulation can be neutralized by either of two means. One way to reduce the charge accumulation is by the diffusion of the charge during the battery cell rest cycle. A second, faster way, to reduce the charge accumulation is to charge the battery cell by reverse current. The reduction in the charge accumulation and the resultant diminishment of the double layer effect is accelerated by applying reverse charge current after a properly timed charging duty cycle. FIG. 4 illustrates the charge/discharge logic of an embodiment.

Thus, a battery cell can output more power if it is discharged in a controlled intermittent manner. Furthermore, a way to accelerate the diminishment of the polarization resistance that arises as a result of the double layer effects by applying reverse current charge after a properly timed duty cycle.

Controlling the discharge of the cell also has advantages such as increasing the useful life of the cell and sustaining its ability to hold a charge. Described above are the advantages of charging the cell intermittently. Combining the pulse charging method with the pulse discharge method allows the battery cell to derive appreciably more energy. During the battery cell discharge, the voltage of the cell can be divided into following different processes.
1. The total equilibrium voltage is the battery cell voltage when no current is flowing. The equilibrium voltage depends solely on the state-of-charge of the battery cell.
2. The kinetic over-potential (g-kinetic) is the over-potential for the charge transfer reaction at the positive and negative electrodes.
3. The diffusion over-potential reflects the concentration differences within the electrodes. Diffusion over-potentials in the electrodes are a result of the difference in composition of the electrode material at a position in the electrode very close to the back contact and at a position very close to the electrode/electrolyte solution interface.
4. Within the same electrolyte solution, a concentration gradient exists, giving rise to a Nernstian potential difference.

The first two processes cannot be changed as they are determined by battery cell charge status and battery cell reaction speed. However the last two processes (potential drops) can be modified and should be minimized as they are counter effective. As shown in FIG. 8, one embodiment of this invention comprises at least two battery cell packs 501 & 503 that provide power to the device for a fraction of cycle. Thus, each battery cell and/or battery cell pack is equal to a pulse discharge. No disruption of output power supply exists as the battery cell packs provide the power alternatively. To further ease the adverse effects of the last two processes identified above, this embodiment employs a fast charging current on the idle battery cell. Adverse effects are further decreased by balancing the voltage in the individual cells. (The cell balancing feature of the invention is described in more detail below). The charging and balancing is done by battery pack 505 using the charging/discharging module 607.

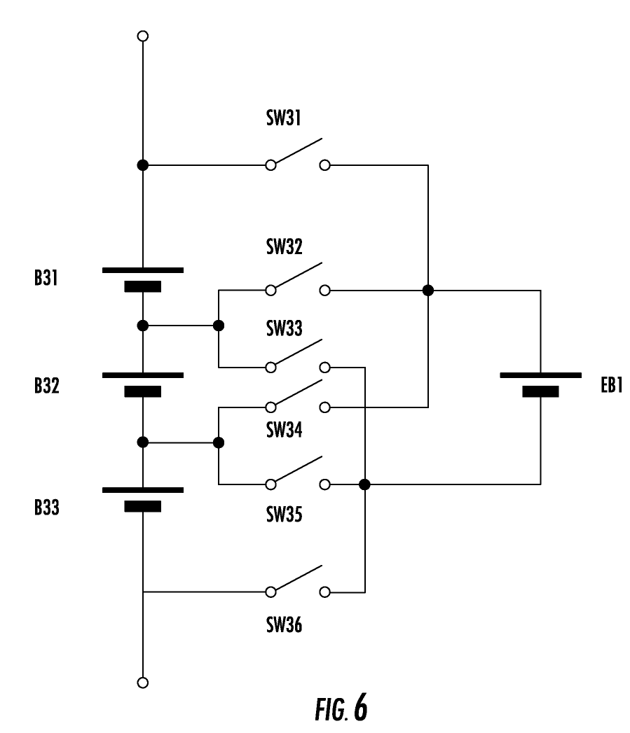

An embodiment disclosed in FIG. 6 illustrates a fast solid-state micro-switch 607 as charging/discharging module 607 which selects a first battery cell pack 501 and a second battery cell pack 503 for charging and discharging alternatively. This process may be controlled by the device firmware installed in the controller 507. The frequency of selection may be adaptively changed, as required, to frequencies less than 1 Hz and up to 1 kHz. During the discharging period of the first lithium polymer battery cell pack 501, the nickel metal hydride battery cell pack 505 is used to charge the second (idle) lithium polymer battery cell pack 503.

The controller 507 determines the rate the batteries are discharged and, through the charging unit 607, controls the amplitude, duration and frequency of the discharge. The benefit of the pulse discharge methodology is that the electrochemical reaction of battery cell recovers from the undesired voltage accumulation on the double layer. To further limit the reverse voltage accumulation on the double layer, a charge current pulse is applied during the free duty of the discharge cycle. The pulse discharge methodology results in more energy output from the lithium battery packs 501 & 503 including each individual cell when compared to existing discharge methods.

Another feature of the invention is the cell balancing system and method. A traditional lithium battery cell system in a notebook computer or mobile device uses several battery cells with the same capacity connected in a series. The connected battery cells should have the same voltage at the beginning. However, due to aging, manufacturing defects, or other issues, the voltage status of the cells will not always remain the same. As a result, the battery cells may become unbalanced. This may cause severe problems either with safety and/or efficiency. For example, if there are two lithium cells that are connected in series, ideally both cells would reach regular capacity of 4.25V when the charging ends. However, if those two cells are not balanced (i.e. cell A is charged faster than cell B) then problems can occur in both the charging and discharging phase.

In the charging process, a traditional charger has one of two criteria for stopping the charging. Either the total voltage reaches a predetermined value (i.e. 8.5V) or the voltage of one of the battery cells reaches the predetermined value (i.e. 4.25V). If the charger uses the first criteria, it assumes that cell A has the same voltage as cell B when the charge begins. The charger will continue charging the cells until the total voltage reaches 8.5V. In this case, if the cells are not balanced because cell A charged faster than cell B, cell A will be overcharged and cell B will be undercharged. As cell A was charged to exceed its regular capacity of 4.25V it become dangerous. As cell B was undercharged, it leads to underutilization and inefficiency. If the charger uses the second criteria, it will stop when cell A reaches 4.25V and because cell A charged faster than cell B, cell is undercharged and the battery pack has not been charged fully.

In the discharging process, similar problems occur under either scenario since cell B holds lower capacity then cell A and will discharge its energy to the maximum level sooner. As a result, the discharging process must end when cell B reaches a predetermined maximum discharge value even if cell A still holds some capacity.

The existing solutions for the balance problem use either resistances or capacitors to balance the cells. More specifically, the resistances or capacitors are hooked to a certain cell to provide the extra current route to control the charging and discharging rate. However these passive methods are not very effective and their efficiency decreases dramatically when the cell voltage difference is larger than 0.3V. Additionally, the resistance method only works during the charging phase and cannot balance the cell in the discharging phase.

As mentioned above, it is beneficial for all battery cells to carry an equal charge. However, due to aging and manufacturing defects, multiple battery cells come out of equilibrium so that a first cell carries a higher charge than a second cell. FIG. 6 shows one embodiment of the active cell balance system. As shown in this embodiment, three secondary battery cells, B31, B32, and B33 are connected in series. The balance is achieved by connecting with an extra secondary battery EB1. Six switches have been used to make the EB1 separately connect each of the three secondary cells in parallel. For example, when only SW31 and SW33 are turned on, EB1 is connected with B31 in parallel. When only SW32 and SW35 are turned on, EB1 is connected with B32 in parallel. When only SW34 and SW36 are connected, EB1 is connected with B33 in parallel. The extra secondary battery EB1 also works to transfer the extra charge from higher voltage cell to lower voltage cell. If the cells are not balanced as V_{B31}>V_{B32}>V_{B33}, and voltage of EB1 is higher than V_{B33}. W34 and SW36 are turned on and other switched are turned off. EB1 is connected with B33 in parallel to assist its discharging load. After a period of time T, the voltage of B31 and the voltage of EB1 are equal, and B33 is charged by EB1. If EB1 does not have enough capacity to share the discharging load, it will be connected with the high voltage cell to speed up its discharging rate. That is, SW31 and SW33 are turned on and all other switches are turned off. Thus, EB1 is connected with B31 in parallel. After a period of time T, the voltage of EB1 equals to the voltage of B31. EB1 is charged by B33. The process works to move the charge from B31, which has higher voltage, to B33, which has lower voltage. The balance process will continue until the cells are all balanced as V_{B31}=V_{B32}=V_{B33}.

The above embodiment is an example of an active cell balance mechanism that can be used to balance battery cells. Compared with the traditional passive cell balance method using resistance or capacitor, this active cell balance method is more effective. The active cell balancing mechanism allows for optimal cell capacity balancing between electrically joined cells. By combining intelligent charging methods with active charge status sensing of the individual cell and all electrically connected cells, this cell balancing methodology allows for the logical and physical matching of cells with the required load (demand placed upon the cell or combination of cells).

In some embodiments, the cells can also be balanced during the charging phase. In the charging phase, when one group of battery cells is to be charged, the cell in the idle group can act as the power source for cell balancing for the active group. More specifically, the cell with the highest voltage will be adaptively connected in parallel with one idle cell, so the charging current of this high voltage cell can be bypassed and the charging rate of this cell can be slowed down. In this way, the balance of the whole group can be achieved.

In some embodiments, the cells can also be balanced during the discharge phase. During the discharging phase, an idle cell can be selectively hooked with certain active cell(s) to share the load and to help balance the active battery cells. During charging phase, an idle cell can be hooked with a cell to bypass the charging current. This bypass of the charging current will slow down the charging process of a cell with high voltage so that balance of the battery cells is achieved when the charging process ends. When one group of battery cells is active and discharging, the appropriate cell will be adaptively connected in parallel with one idle cell, which helps to transfer the energy between battery cells. This process is repeated during the whole discharging phase at adaptive and/or predetermined times. In this way, the cells are properly balanced.

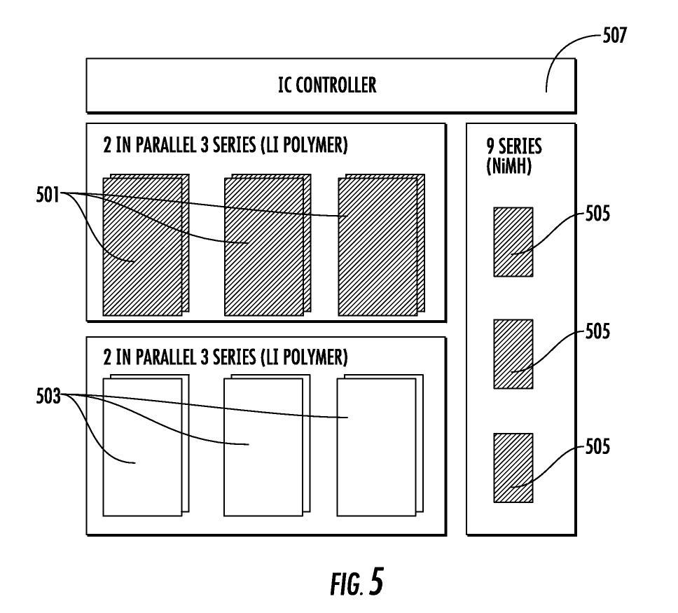

An embodiment of the invention reveals that the charging and balancing of lithium battery packs 501 and 503 by using a nickel battery pack 505 has certain advantages. Referring to FIG. 5, an embodiment has two groups of lithium cells each group is formed into a respective pack 501 & 503. Each battery pack 501 & 503 can provide the necessary power for the device independently. A group of nickel metal hydride battery cells are formed into a battery pack 505 and are included to provide the short charge current to counter the negative effects of the double layer discussed above. The discharge profile of the nickel metal hydride battery cell pack 505 is very appropriate for optimal support and timing of its required functions. The nine nickel metal hydride batteries also power the controller 507 and take part in the discharge phase.

In an embodiment the controller 507 also manages the primary charging from a commercial main of AC, 120V for example. In one embodiment, AC voltage is converted to DC and used to charge the nickel battery pack 505. The battery management system 500 then causes the nickel battery pack 505 to transfer its charge, using the methods disclosed above, to the lithium battery packs 501 & 503. The nickel battery pack 505 has charging advantages over the lithium type cells. Consequently, it responds more efficiently to charging from an AC source. The intelligent battery management system 500 uses the nickel battery's advantages to optimally charge each battery pack. However, one skilled in the art would easily recognize the battery management system 500 disclosed could manage the commercial main charging of any one or all the battery packs.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

What is claimed is as follows:

1. A battery cell management system comprising:
a cell condition monitoring unit for measuring the condition of the cell;
a charging module operatively connected to the cell adapted to selectively charge the cell; and
a control unit adapted to receive data from the cell condition monitoring unit and to control the charge produced by said charging module.

2. The system of claim 1 wherein said cell condition monitoring unit comprises a temperature sensor for sensing the temperature of the cell.

3. The system of claim 1 wherein said cell condition monitoring unit comprises a deformation sensor for sensing a change in shape of the cell.

4. The system of claim 3 wherein said deformation sensor is a strain gauge wheat stone bridge.

5. The system of claim 1 wherein said cell condition monitoring unit comprises a galvanostatic pulse detector operatively connected to the cell for monitoring the cell's response to a galvanostatic pulse injected into the cell.

6. The system of claim 1 wherein said cell condition monitoring unit comprises a cell voltage detector for measuring the voltage across the cell.

7. The system of claim 1 wherein said cell condition monitoring unit comprises a current density detector for measuring the current density of the cell.

8. The system of claim 1 wherein said cell condition monitoring unit comprises a cell internal resistance detector for measuring the internal resistance of the cell.

9. The system of claim 1 wherein said charging module is adapted to produce a plurality of types of charges including constant, variable, and flutter.

10. The system of claim 9 wherein said charging module provides the appropriate type and duration of charged in response to conditions determined by said control unit.

11. The system of claim 1 wherein the charging module provides a first flutter charge pattern to the cells and a second flutter charge pattern to the cells and the control unit determines which flutter charge pattern provides the most effective charge to the cells.

12. The system of claim 1 further comprising a discharge control unit to safely control the discharge of the cell in response to changed conditions of the cell.

13. A battery cell balancing system for balancing voltages among a first plurality of cells using a second cell, said system comprising:
a cell condition monitoring unit for measuring the voltage of the first plurality of cells and the second cell;
a plurality of switches each having an open position where current is allowed to pass and a closed position where current is not allowed to pass, wherein one switch is located between each of the first plurality of cells and the second cell to selectively allow current to pass between any one of the first plurality of cells and the second cell;
a control unit adapted to receive data from the cell condition monitoring unit, use that data to determine whether the cells in the first plurality of cells are balanced, and control the opening and closing of the plurality of switches.

14. The system of claim 13 wherein the first plurality of cells comprises an alpha battery cell and a beta battery cell and the alpha battery cell has a higher charge than the beta battery cell.

15. The system of claim 14 wherein the alpha battery cell from the first plurality of cells is used to charge said second cell, then said second cell is used to charge the beta battery cell from the first plurality of cells.

16. The system of claim 13 wherein in said first plurality of cells are Lithium polymer cells.

17. The system of claim 13 where in said second cell is a Nickel Metal Hydride cell.

18. A system for balancing battery cells comprising:
a first plurality of cells in series;
a second cell selectively in parallel with each cell in said first plurality of cells;
a charging module for selectively connecting said second cell in parallel with at least one of said cells in said first plurality of cells;
a voltage detector for detecting the voltage in each of said cells;
a controller connected to said charging module, wherein the charging module selectively connects said second cell in parallel with one of said first plurality of cells until said first plurality of cells are operatively balanced in response to an imbalance of voltage among each said first plurality of cells.

19. The system of claim 18 wherein the chemistry of said first plurality of cells is different from said second cell.

20. The system of claim 19 wherein in said first plurality of said cells are Lithium polymer cells.

21. The system of claim 19 where in said second cell is a Nickel Metal Hydride cell.

22. The system of claim 18 further comprising a cell condition monitoring unit having cell health sensors wherein said controller is adapted to calculate load data received from said sensors through said cell condition monitoring unit, wherein said calculated data is used to determine which of said cells supply the load.

23. The system of claim 22 wherein said controller is adapted to predict future conditions based on data received from said cell condition monitoring unit.

24. The system of claim 22 wherein said sensors comprise a temperature sensor for sensing the temperature of the cell.

25. The system of claim 22 wherein said sensors comprise a deformation sensor for sensing a change in shape of the cell.

26. The system of claim 25 wherein said deformation sensor is a strain gauge wheat stone bridge.

27. The system of claim 22 wherein said sensors comprise a galvanostatic pulse detector operatively connected to the cell for monitoring the response of the cell to a galvanostatic pulse injected into the cell.

28. The system of claim 22 wherein said sensors comprise a cell voltage detector for measuring the voltage across the cell.

29. The system of claim 22 wherein said sensors comprise a current density detector for measuring the current density of the cell.

30. The system of claim 22 wherein said sensors comprise a cell internal resistance detector for measuring the internal resistance of the cell.

31. The system of claim 22 further comprising a charging module, wherein said controller calculates the desired charge from current and historical cell health data and said charging module controls the charge produced by said second cell for said first plurality of cells.

32. The system of claim 31 wherein said charging module is adapted to produce a plurality of types of charges including constant, variable, and flutter in response to conditions determined by said control unit.

33. The system of claim 18 wherein the charging module provides a first flutter charge pattern to the cells and a second flutter charge pattern to the cells and the control unit determines which flutter charge pattern provides the most effective charge to the cells.

34. The system of claim 32 wherein said control unit predicts future conditions of the cell.

35. The system of claim 34 wherein said control unit controls the charge produced by said charging module in response to predicted conditions.

36. The system of claim 22 further comprising a discharge control unit to control the discharge of the cells in response to changed conditions of the cells.

37. A system for controlling battery discharge comprising:
a first battery having a plurality of cells;
a second battery having a plurality of cells in parallel with said first battery pack;
a third battery having a plurality of cells in parallel with said first and second battery pack;
a voltage detector for monitoring the voltage of each of said cells in said batteries; and
a controller for selectively rotating discharge among the first and second batteries, wherein the discharging battery is the active battery and the other battery is the idle battery, wherein as one of said first and second batteries is discharging, the idle battery is being charged by said third battery.

38. The system of claim 37 wherein said first and second batteries are Lithium based batteries.

39. The system of claim 38 wherein the third battery is a Nickel hydrate battery.

40. The system of claim 37 further comprising an active cell balance unit, wherein said voltage detector detects the voltage in each of said batteries; and a switching unit selectively connects the idle battery in parallel with the third battery, wherein said controller is connected to said micro switch array for switching in response to an imbalance of voltage among each said first plurality of cells, wherein said controller selectively individually connects the idle cells in parallel with the cells in said third battery pack until said idle cells are operatively balanced.

41. The system of claim 37 further comprising a cell condition monitoring unit for measuring conditions in and around the cells, wherein said controller switches between said first and second batteries in response to changing conditions in said batteries.

42. The system of claim 37 wherein said controller varies the charge being produced by said third battery to the idle battery between a constant, pulse, and flutter charges.

43. A method for balancing a plurality of series connected battery cells and a selectively connected parallel battery cell comprising the steps of:
sensing a voltage of said parallel cell;
sensing voltages of said series connected cells;
recognizing the voltages of the series connected cells are not balanced;
determining whether the voltage of the parallel cell is greater than the highest voltage of the series connected cells; and
charging the series cells with the parallel cell until voltages of the series cells are substantially balanced.

44. The method of claim 43 further comprising the step of charging the parallel cell with the series cell having the highest voltage until the voltages are substantially balanced.

45. The method of claim 44 further comprising the step of charging the series cells individually with the parallel cell until voltages of the series cells are substantially balanced.

46. A method for preventing battery cell failure with an intelligent microcomputer and adaptive control logic adapted to receive cell condition data from safety sensors comprising the steps of:
storing default limits for the cell;
receiving initial data from the safety sensors and associating said data with the cell in new condition;
updating the initial data with current data from the safety sensors;
comparing said current data with said default limits;
isolating the cell before the cell enters an unsafe state.

47. The method of claim 46, wherein the step of receiving data from the safety sensors further includes the step of receiving temperature data from a thermistor.

48. The method of claim 46 wherein the step of receiving data from the safety sensors further includes the step of receiving deformation data from a strain gauge wheatstone bridge.

49. The method of claim 46 wherein the step of receiving data from the safety sensors further includes the steps of receiving decay data by measuring a response to a galvanostatic pulse injected into the cell.

50. The method of claim 46 further comprising the step of calculating internal battery cell resistance.

51. The method of claim 46 further comprising the step of projecting internal battery cell resistance.

52. A method for charging a battery cell using an intelligent microcomputer and an adaptive controller capable of storing a history of cell health data received from a plurality of sensors comprising the steps of:
measuring current cell health data with the plurality of sensors;
comparing the cell health data with historical cell health data;
calculating an optimum charge based on compared data;
sending a charge to the cell based on said calculated value; and
modifying the charge based on changing conditions of the cell.

53. The method of claim 52 wherein the step of measuring cell health data further includes the step of measuring temperature data from a thermistor.

54. The method of claim 52 wherein the step of measuring cell health data further includes the step of measuring deformation data from a strain gauge wheatstone bridge.

55. The method of claim 52 wherein the step of measuring cell health data further includes the step of measuring decay data by injecting a galvanostatic pulse into the cell.

56. The method of claim 52 wherein the step of measuring cell health data further includes the step of measuring cell voltage.

57. The method of claim 52 wherein the step of measuring cell health data further includes the step of measuring the current density of the cell.

58. The method of claim 52 wherein the step of modifying the charge further includes changing the charge from constant current to pulse charging.

59. The method of claim 52 wherein the step of modifying the charge further includes changing the charge from pulse charging to flutter charging.

60. A computer enabled method for protecting battery health comprising the steps of:
recognizing that the battery is connected to a device adapted to produce charges including constant current, pulse and flutter;
measuring battery health conditions;
predicting based on battery health conditions when the battery is going to enter unsafe conditions; and
aborting charging before the battery enters unsafe conditions.

61. A battery cell management system comprising:
a cell condition monitoring unit for measuring the condition of the cell;
a charging module operatively connected to the cell adapted to selectively charge the cell; and
a control unit adapted to receive data from the cell condition monitoring unit and use that data to determine future conditions inside the cell, said control unit also adapted to control the charge produced by said charging module in response to determined future conditions.

62. A system for controlling battery discharge comprising:
a first battery;
a second battery in parallel with said first battery pack;
a controller for selectively rotating discharge among the first and second batteries.
